(19) United States
(12) Patent Application Publication
(10) Pub. No.: US 2004/0010327 A1
(43) Pub. Date: Jan. 15, 2004

(54) Home gateway for automatically acquiring and updating modules for controlling home electronics devices

(75) Inventors: Yoshiki Terashima, Yokohama-shi (JP); Keiichi Teramoto, Kawasaki-shi (JP); Takeshi Saito, Tokyo (JP); Yuzo Tamada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/458,224

(22) Filed: Jun. 11, 2003

(30) Foreign Application Priority Data
Jun. 12, 2002 (JP) P2002-171731

(51) Int. Cl. G05B 15/00

(52) U.S. Cl. 700/83

(57) ABSTRACT

A communication control device connected to a home network and an external network is formed by a control unit configured to give prescribed commands to home electronics devices through the home network; a Web server unit configured to provide an interface in a form of a Web screen for controlling one home electronics device requested by a terminal device, to the terminal device on the home network, and give a prescribed command for the one home electronics device given from the terminal device through the interface in a form of the Web screen, to the control unit; and an acquisition unit configured to automatically acquire a latest version of a file necessary in producing the interface in a form of the Web screen for controlling each home electronics device, from a prescribed server device corresponding to each home electronics device, through the external network.

### BACKGROUND OF THE INVENTION

1. Field of the Invention

The present invention relates to a communication control device and a communication control method for controlling home electronics devices on a home network using a terminal device on the home network as a controller.

2. Description of the Related Art

In recent years, the home electronics devices are rapidly becoming digital and highly functional. For example, a BS digital broadcast compatible TV, a digital VHS, a digital HDD recorder, etc., are connected by the IEEE 1394 and the control and video transfer using digital signals have been realized. The capturing, editing, rewriting, etc., between the PC and the AV device are supported as new functions not available in the conventional AV device.

Also, for the living related home electronics device such as air conditioner and washing machine, the network compatibility beyond the conventional infrared remote controlling is widely discussed, and the research and development of a centralized device control and state monitoring, the device coordination, etc., are currently made by various makers.

On the other hand, the advance of the network infrastructure such as portable telephone, Internet, etc., are also remarkable. The notable example includes the spread of the broadband compatibility and the constant Internet access environment in the home. Also, there is an expectation of a realization of new services such as a video recording reservation with respect to a home AV compatible PC via the Internet from a portable telephone.

The candidates for a device to play a role of a remote controller for controlling these various home electronics devices include PC, PDA, portable telephone, etc. However, if the home electronics device itself is to provide a control screen or a control software module individually with respect to such various controllers, the burden on the home electronics device would be too heavy.

On the other hand, the standardization of the control protocols for the home electronics devices is in progress for the AV home electronics devices and the living related home electronics devices, and the home electronics devices are expected to be connected to a network in a form according to these control protocols.

In view of such a state of affairs, there are several propositions for a model which arranges a centralized server for controlling and monitoring various home electronics devices in the home. Namely, it is a model in which a home server that supports various standard protocols for controlling the home electronics device will be controlling and monitoring the devices in a centralized manner, such that the controller such as PC or PDA will control the home electronics device through this home server. The home server itself may be provided with a display and an input device to play a role of the controller, but it is preferable to select the controller according to the preference and the location of the user.

In such a case, the home electronics device control will be requested to the home server via a network from an external controller such as PC, and the communication protocol to be used between the external controller and the home server is not necessarily in compliance with the control protocol to be used between the home server and the home electronics device. The candidates for the communication protocol for general use include HTTP and HTTPS that are generally supported by the Web browsers implemented on various controllers, on which HTML or XML can be utilized. In a model for arranging various modules necessary for the control of the home electronics devices on the home server, the control module that becomes newly necessary when a new home electronics device is introduced can be added to the home server alone.

Conventionally, in the case of the PC, for example, in order to install a software module necessary in utilizing a peripheral device to be connected to the PC into the PC, there is a need to download this software module explicitly by the user's manual operation from a CD-ROM or a server on the Internet. In today's OS, it is also possible to notify a detection of the updated version of the software module to the user by regularly inquiring the server on the Internet from a monitoring program on the OS, but the actual downloading operation must be carried out manually by the user.

In the case of the home server, the update of the software module should preferably be made easily even by a user who is unfamiliar with the PC, and if possible, it should preferably be made automatically. In addition, unlike the case of the PC described above, the software module for controlling devices will be placed and executed on the home server, but the control screen display or the user operation program will be downloaded and executed on the controller side, so that there is a need to reflect the updated version of the program on the controller side in order to always use the latest control software module.

However, conventionally, there has been no way of resolving these programs simultaneously.

### BRIEF SUMMARY OF THE INVENTION

It is therefore an object of the present invention to provide a communication control device and a communication control method capable of automatically acquiring and updating modules for controlling home electronics devices connected on the home network.

According to one aspect of the present invention there is provided a communication control device connected to a home network and an external network, comprising: a control unit configured to give prescribed commands to home electronics devices through the home network; a Web server unit configured to provide an interface in a form of a Web screen for controlling one home electronics device requested by a terminal device, to the terminal device on the home network, and give a prescribed command for the one home electronics device given from the terminal device through the interface in a form of the Web screen, to the control unit; and an acquisition unit configured to automatically acquire a latest version of a file necessary in producing the interface in a form of the Web screen for controlling each home electronics device, from a prescribed server device corresponding to each home electronics device, through the external network.

According to another aspect of the present invention there is provided a communication control method of a communication control device connected to a home network and an external network, comprising: acquiring a location information indicating a location on the external network of a file necessary in producing an interface in a form of a Web screen for controlling a new home electronics device, from the new home electronics device detected on the home network; automatically acquiring a latest version of the file according to the location information when a prescribed condition holds; and providing the interface in a form of the Web screen for controlling one home electronics device requested from a terminal device on the home network, according to the file, in response to a request from the terminal device.

According to another aspect of the present invention there is provided a computer program product for causing a computer to function as a communication control device connected to a home network and an external network, the computer program product comprising: a first computer program code for causing the computer to give prescribed commands to home electronics devices through the home network; a second computer program code for causing the computer to provide an interface in a form of a Web screen for controlling one home electronics device requested by a terminal device, to the terminal device on the home network, and give a prescribed command for the one home electronics device given from the terminal device through the interface in a form of the Web screen, to the first computer program code; and a third computer program code for causing the computer to automatically acquire a latest version of a file necessary in producing the interface in a form of the Web screen for controlling each home electronics device, from a prescribed server device corresponding to each home electronics device, through the external network.

Other features and advantages of the present invention will become apparent from the following description taken in conjunction with the accompanying drawings.

### BRIEF DESCRIPTION OF THE DRAWINGS

FIG. 1 is a block diagram showing an exemplary configuration of a network system according to one embodiment of the present invention.

FIG. 2 is a block diagram showing an exemplary configuration of a home gateway according to one embodiment of the present invention.

FIGS. 3A and 3B are diagrams showing exemplary screens for a home electronics device control displayed on a Web browser of a terminal device according to one embodiment of the present invention.

FIG. 4 is a block diagram showing one exemplary configuration of an ASP server according to one embodiment of the present invention.

FIG. 5 is a flow chart showing one exemplary file acquisition procedure according to one embodiment of the present invention.

FIG. 6 is a diagram showing an exemplary home electronics device information registered in a home electronics device database according to one embodiment of the present invention.

FIG. 7 is a diagram showing a processing flow at a time of displaying an initial screen for a home electronics device control on a Web browser of a terminal device according to one embodiment of the present invention.

FIG. 8 is a diagram showing a processing flow at a time of changing a screen for a home electronics device control displayed on a Web browser of a terminal device according to one embodiment of the present invention.

FIG. 9 is a diagram showing a processing flow at a time of specifying a command for a home electronics device on a screen for a home electronics device control displayed on a Web browser of a terminal device according to one embodiment of the present invention.

FIGS. 10A and 10B are diagrams for explaining one possible way of acquiring file according to one embodiment of the present invention.

FIGS. 11A and 11B are diagrams for explaining another possible way of acquiring file according to one embodiment of the present invention.

FIGS. 12A and 12B are diagrams for explaining another possible way of acquiring file according to one embodiment of the present invention.

FIGS. 13A and 13B are diagrams for explaining another possible way of acquiring file according to one embodiment of the present invention.

FIG. 14 is a flow chart showing another exemplary file acquisition procedure according to one embodiment of the present invention.

FIG. 15 is a block diagram showing another exemplary configuration of an ASP server according to one embodiment of the present invention.

FIG. 16 is a flow chart showing another exemplary file acquisition procedure according to one embodiment of the present invention.

FIG. 17 is a diagram showing an operation sequence in a case of judging whether a file is new or old by comparing updated date and time according to one embodiment of the present invention.

FIG. 18 is a diagram showing an operation sequence in a case of judging whether a file is new or old by using CGI according to one embodiment of the present invention.

### DETAILED DESCRIPTION OF THE INVENTION

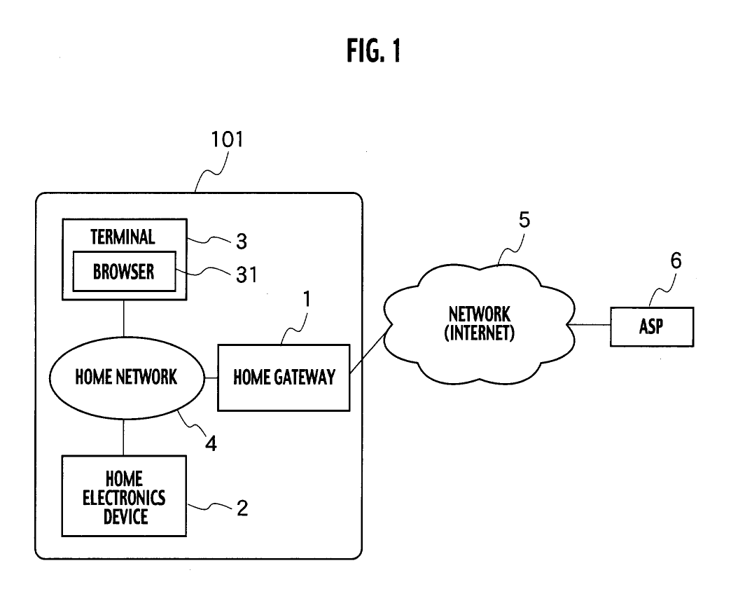

Referring now to FIG. 1 to FIG. 18, one embodiment of the present invention will be described in detail.

FIG. 1 shows an exemplary configuration of a network system according to one embodiment of the present invention. Here, a home network 4 is provided inside some home 101. This home network 4 and an ASP (Application Service Provider) server 6 are connected to an external network (which will be assumed to be the Internet) 5.

There is also provided a home gateway (HGW) 1 as a junction between the Internet 5 and the home network 4. The home gateway 1 has an interface with respect to the Internet 5 and an interface with respect to the home network 4. These interfaces may be physically separate ones, or physically identical but logically separated ones.

In the home 101, the home gateway 1, a home electronics device 2 and a terminal device 3 are connected to the home network 4. Note that, in FIG. 1, there is only one home electronics device 2, but it is obviously also possible to connect a plurality of home electronics devices. Note that, in this embodiment, the exemplary case of using an air conditioner as a concrete example of the home electronics device 2 will be mainly described.

Here, the Internet protocol can be supported not only by the home gateway 1 but also by the home electronics device 2 or the terminal device 3. In the case of using the Internet protocol for the communications between the home gateway 1 and the terminal device 3, there is a need to support the Internet protocol at the terminal device 3, and the same is also true for the home electronics device 2.

The terminal device 3 or the home electronics device 2 in the case of supporting the Internet protocol may or may not be capable of carrying out communications directly with a device (the ASP server 6, for example) on the Internet 5 by using TCP/IP or the like. Note that, in the following, it is assumed that the terminal device 3 and the home electronics device 2 have the private IP addresses, and do not carry out communications directly with the ASP server 6, but the terminal device 3 and the home electronics device 2 of this embodiment may have unique global IP addresses in addition to or instead of the private IP addresses.

The home network 4 can physically be a radio LAN such as Bluetooth or 802.11, but many variations are possible, including the case where various networks are mixedly used, such as the case in which some devices are connected by the Bluetooth and some devices are connected to the Ethernet or the IEEE 1394.

This embodiment is directed to an exemplary case where the terminal device 3 connected to the home network 4 plays a role of a home electronics device controller for controlling a desired home electronics device through the home gateway 1. Note that any of various types of devices such as PC, TV, portable telephone terminal, PDA, etc., can be used as the terminal device 3.

Also, this embodiment is directed to an exemplary case of utilizing a Web browser as a remote control screen for the home electronics device control. The Web browser will provide an interface for controlling the home electronics device in a form of a Web screen. Namely, when the terminal device 3 is the home electronics device controller, the control screen for controlling one home electronics device is displayed on the Web browser 31 on the terminal device 3, The control screen for controlling one electronics device is formed by CGI (Common Gateway Interface) files, image files, etc., dedicated for that home electronics device.

Also, this embodiment is directed to an exemplary case of utilizing the ECHONET for the purpose of controlling the home electronics device 2. The ECHONET defines commands, protocols, objects, API, etc., for controlling equipment type devices (home electronics devices) on various physical media such as electric power line, twist pair line, etc. Further details can be found in documents disclosed and available at “http://www.ECHONET.or.jp”.

Note that, in FIG. 1, only one home network 4 and only one ASP server 6 are shown, but it is obviously also possible to have a plurality of home networks and a plurality of ASP servers on the Internet 5.

In the following, the home gateway 1 connected on the home network 4 will be described in detail.

As shown in FIG. 1, the home gateway 1 is connected to the ASP server 6 outside of the home 101 through the Internet 5.

This home gateway 1 has a home electronics device control function for controlling the home electronics device 2 connected to the home network 4, a Web server function for providing a screen or interface for the home electronics device control with respect to the terminal device 3 that has the Web browser 31, and a function for providing services for the home electronics devices through the Internet 5 by accessing the ASP server 6 connected to the Internet 5. The home gateway 1 coordinate these functions (the home electronics device control function, the Web server function, the ASP server access function) together and provides services in which these functions are integrated.

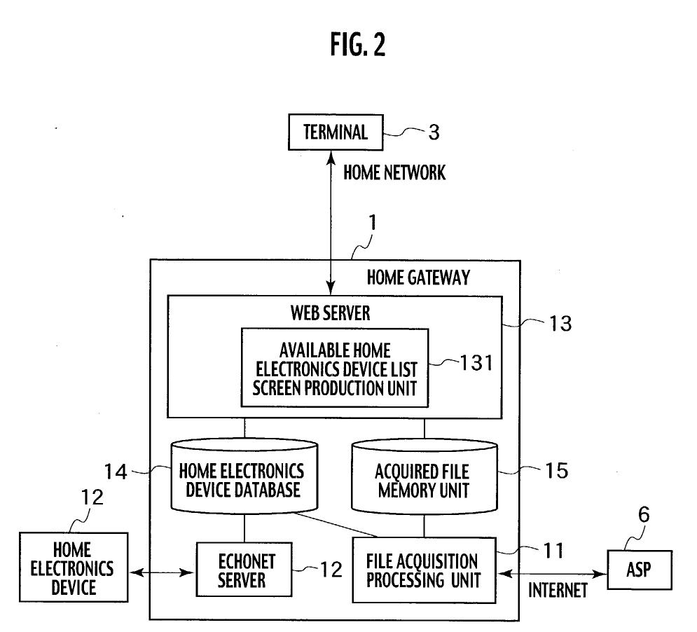

FIG. 2 shows an exemplary configuration of the home gateway 1. As shown in FIG. 2, the home gateway 1 has a file acquisition processing unit 11, an ECHONET server 12, a Web server 13 for home use, a home electronics device database 14, and an acquired file memory unit 15.

The ECHONET server 12 has a function for controlling the home electronics device 2 according to the ECHONET protocol.

Also, the ECHONET server 12 has a function for searching through the home network 4, automatically detecting the home electronics device connected to the home network 4, acquiring the home electronics device information regarding the detected home electronics device from that home electronics device, and notifying this information to the home electronics device database 14.

The home electronics device database 14 stores the home electronics device information notified from the ECHONET server 12. Note that the home electronics device database 14 may also has a function of a static database (such as that for the home electronics device information registered in advance or information regarding the home electronics device that are regularly sent from the ASP server 6, for example), in addition to the function for storing the home electronics device information that is dynamically acquired as described above.

Note that the ECHONET server 12 can also be utilized from the other program. For example, the ECHONET server 12 can be utilized in the case where the other program sends a control command for the home electronics device control or acquires information.

The file acquisition processing unit 11 has a function for acquiring a file (a program for controlling the home electronics device (including CGI, script, etc.)) for the home electronics device detected by the ECHONET server 12, from the ASP server 6 corresponding to that home electronics device. The file acquired by the file acquisition processing unit 11 is stored in the acquired file memory unit 15, in correspondence to information for identifying that home electronics device (such as an identification number or a device name, for example).

Now, the program for the home electronics device control stored in the acquired file memory unit 15 has a possibility of being updated at a suitable timing by the ASP server 6. For this reason, the file acquisition processing unit 11 also has a function for acquiring files of programs for the home electronics device control by carrying out communications with the ASP server 6 through the Internet 5 and updating the acquired file memory unit 15, when a prescribed condition is satisfied.

Note that a concrete example to be described below is directed to the case where a file of the program for controlling the air conditioner is “airconditioner.cgi”, and its URL is “http://asp/httpd/cgifiles/airconditioner.cgi”.

The Web server 13 for home use is a Web server that is expected to be accessed from the terminal device 3 (such as PC, TV, portable telephone, PDA, etc., for example) which has the Web browser 31 and which is connected to the home network 4.

The Web server 13 for home use is provided with an available home electronics device list screen production unit 131, and has a function for dynamically producing a screen for the home electronics device control by using available home electronics device list screen production unit 131 and returning it in response to an access from the terminal device 3.

Also, the Web server 13 for home use has a function for converting commands received in terms of CGI parameters or the like from the terminal device 3 into commands according to the ECHONET protocol and giving them to the ECHONET server 12.

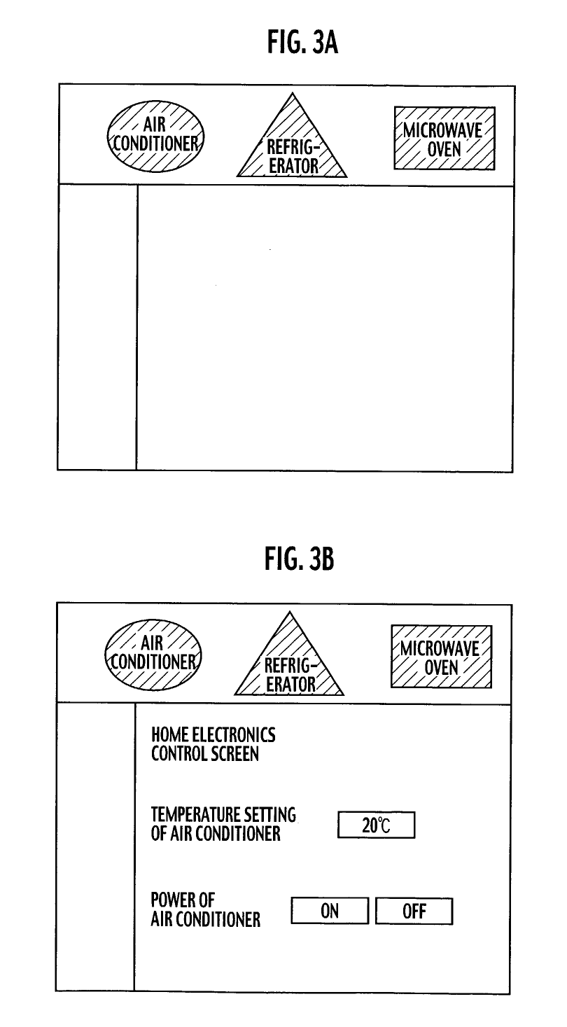

FIGS. 3A and 3B show exemplary screens for the home electronics device control to be displayed on the Web browser 31 of the terminal device 3. For example, when the available home electronics device list screen production unit 131 of the Web server 13 is accessed from the terminal device 3, an available home electronics device list screen as shown in FIG. 3A is displayed on the Web browser 31 of the terminal device 3 as an initial screen, and when an air conditioner button is pressed (by clicking a mouse, for example) on this screen, a screen for controlling the air conditioner as shown in FIG. 3B is displayed.

Then, when a power of the air condition “ON” button is pressed on the screen of FIG. 3B, for example, a message containing a parameter indicating a command for turning the power “ON” for the “air conditioner” is transmitted from the terminal device 3 to the Web server 13 for home use in the home gateway 1. In response to this request, the Web server 13 for home use gives this command for turning the power “ON” for the “air conditioner” to the ECHONET server 12, and the ECHONET server 12 transmits the command for turning the power “ON” for the “air conditioner”.

In this embodiment, it is assumed that each control screen is formed as a Web page. Note that the exemplary screens shown in FIGS. 3A and 3B are those having a frame function, but the present invention is not limited to this case.

The ECHONET server 12 can be realized by executing a program for the ECHONET protocol. The file acquisition processing unit 11 can be realized by executing a program for the file acquisition. The Web server 13 for home use can be realized by executing a program for the Web server. The available home electronics device list screen production unit 131 in the Web server 13 for home use can be similarly realized by executing an available home electronics device screen production program.

Also, the acquired file memory unit 15 and the home electronics device database 14 can be realized by a device having a storage function such as a hard disk provided inside the home gateway 1, for example. The acquired file memory unit 15 and the home electronics device database 14 may be realized by an identical hard disk, or by separate hard disks.

Note that, in the exemplary configuration of FIG. 2, the file acquisition processing unit 11, the ECHONET server 12, the Web server 13 for home use, the home electronics device database 14 and the acquired file memory unit 15 are all implemented in one home gateway 1, but one or more of the file acquisition processing unit 11, the ECHONET server 12 and the Web server 13 for home use may be implemented on one or more of server devices separately from the home gateway 1.

Note that this embodiment is mainly directed to the exemplary case of utilizing the terminal device 3 as a remote control for the purpose of the home electronics device control, but the home gateway 1 itself may contain the Web browser function (and a display function) and this home gateway 1 itself can be utilized as a remote control for the purpose of the home electronics device control.

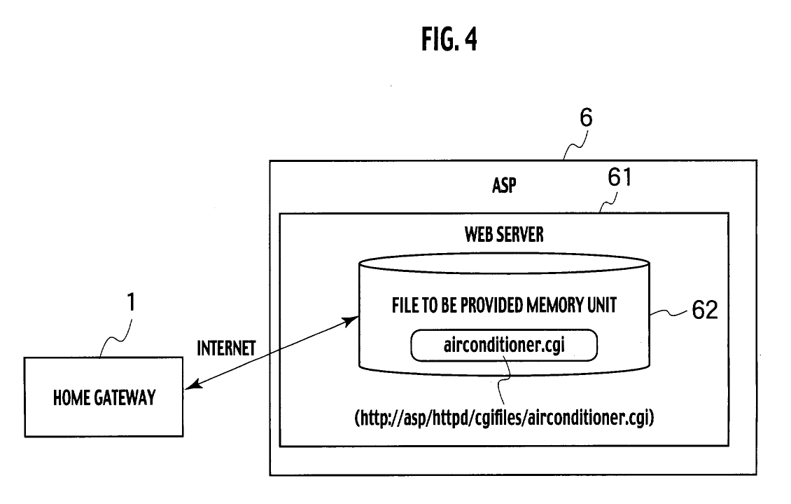

In the following, the ASP server 6 connected on the Internet 5 will be described in detail. FIG. 4 shows an exemplary configuration of the ASP server 6.

The ASP server 6 carries out the services for the home electronics devices through the Internet 5. For example, the ASP server 6 realizes a delivery of programs for the home electronics device control described above, or a delivery of information utilizable by the home electronics device 2 or the terminal device 3 such as information related to some home electronics device 2 (a “recipe” information in the case where the home electronics device 2 is a microwave oven, for example).

The characteristic portion of the ASP server 6 in this embodiment is its function for generating a program for the home electronics device control (a Web page for the home electronics device control, for example) for the benefit of the home gateway 1 and the terminal device 3, and delivering a file of the program. The ASP server 6 has a file to be provided memory unit 62 formed by a hard disk or the like, which stores CGI files, image files, etc., that are necessary in producing the control screen for the individual home electronics device 2.

The home gateway 1 can acquire these files via HTTP by accessing the Web server 61 of the ASP server 6. For example, as shown in FIG. 4, the CGI file “airconditioner.cgi” for controlling the “air conditioner” can be acquired by accessing “http://asp/httpd/cgifiles/airconditioner.cgi”.

The terminal device 3 having the Web browser 31 acquires the Web page for the home electronics device control from the home gateway 1, and realizes the home electronics device control by utilizing this Web page. More specifically, for example, the home gateway 1 converts an appropriate operation on the Web page at the terminal device 3 into a command for the home electronics device control or a command for the ASP server 6, and executes the control.

Note that the Web server 61 can also be realized by executing a program for the Web server.

In the following, the operation in this embodiment will be described in detail.

Here, as a concrete example, suppose that the home electronics device 2 in a form of an air conditioner is connected to the home gateway 1 (through the home network 4) for the first time in some home 101. Here, it is assumed that a dedicated CGI file “airconditioner.cgi” which has a function for generating a HTML document that constitutes the control screen is necessary in order to control this air conditioner (in order to produce the control screen).

At this point, there can be cases where “airconditioner.cgi” does not exist on the home gateway 1 as in the case where this air conditioner is a new home electronics device. For example, if this air conditioner is of a type that was not on sale at a time of the purchase of the home gateway 1 by the user, “airconditioner.cgi” is usually not loaded into the home gateway 1 yet.

Even in the case where “airconditioner.cgi” exists on the home gateway 1 as this air conditioner is not a new home electronics device, there can be cases where there is a new version of “airconditioner.cgi” by the time this air conditioner is actually connected to the home gateway 1 such that “airconditioner.cgi” already loaded into the home gateway 1 is obsolete.

Even when “airconditioner.cgi” already loaded into the home gateway 1 is the latest version by the time this air conditioner is actually connected to the home gateway 1, there can be cases where a new version of “airconditioner.cgi” appears later on so that “airconditioner.cgi” already loaded into the home gateway 1 becomes an old version.

Consequently, there can be requests such as:

(1) that the user newly purchased a home electronics device but a program for controlling it is not in possession so that it is wished to acquire that program; and

(2) that the function of the home electronics device owned by the user can be improved due to the version up of its program so that it is desired to acquire the program in new version to update that program and update the control screen of the home electronics device owned by the user to a new one.

This embodiment enables (1) the automatic new acquisition of a file of the program for controlling the home electronics device 2 connected to the home gateway 1, and (2) the automatic updating of a file of the program for controlling the home electronics device 2 connected to the home gateway 1.

First, the case of automatically newly acquiring the program for controlling the home electronics device 2 connected to the home gateway 1 will be described for an exemplary case of acquiring the CGI file “airconditioner.cgi” necessary for controlling the air conditioner from the ASP server 6.

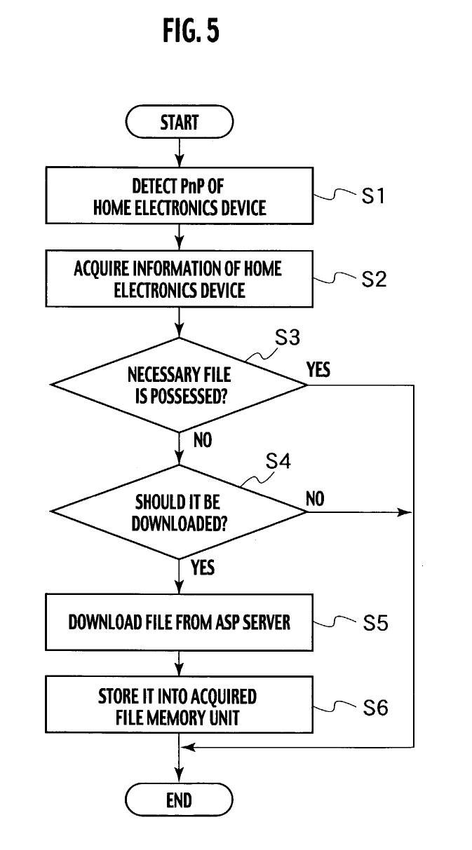

FIG. 5 shows an exemplary file acquisition procedure in this case.

First, the ECHONET server 12 of the home gateway 1 detects that the new home electronics device 2 (which is the air conditioner in this example) is connected to the home network 4 (step S1).

Here, the home electronics device 2 maintains the basic information about itself such as a device type, a manufacturer, etc., in its interior. The home electronics device 2 also maintains information indicating a file necessary in producing the control screen (the program for the home electronics device control) and the location of that file.

In this concrete example, it is assumed that the information maintained indicates that the name of the file necessary in producing the control screen for the air conditioner is “airconditioner.cgi” and this file is located at the ASP outside of the home indicated by the URL “http://asp/httpd/cgifiles/airconditioner.cgi”.

The ECHONET server 12 acquires this home electronics device information, and if it is not already registered in the home electronics device database 14, stores this information into the home electronics device database 14 (step S2).

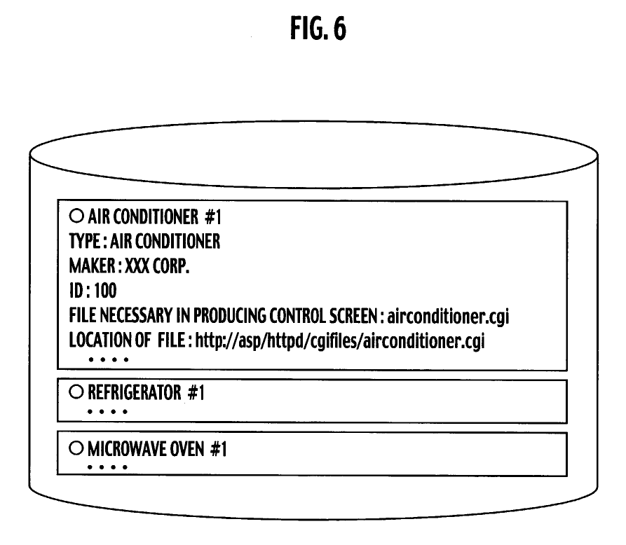

FIG. 6 shows an exemplary state in which the information regarding the air conditioner, the information regarding the refrigerator, and the information regarding the microwave oven are registered in the home electronics device database 14.

Next, the file acquisition processing unit 11 receives the acquired information indicating the name of the file necessary in producing the control screen of the home electronics device and the location of that file through the home electronics device database 14, and checks whether the file necessary in producing the control screen for this home electronics device (which is “airconditioner.cgi” in this example) is stored in the acquired file memory unit 15 of the home gateway 1 or not.

If it is stored there (step S3 YES), the processing is terminated, but here it is assumed that the air conditioner is a new home electronics device 2 so that the home gateway 1 do not have the file “airconditioner.cgi” for controlling this air conditioner (step S3 NO).

In this case, the file acquisition processing unit 11 attempts the downloading of the file “airconditioner.cgi” via HTTP, from a location indicated by the URL “http://asp/httpd/cgifiles/airconditioner.cgi” of the ASP server 6 outside of the home, according to the home electronics device information described above.

If the downloading is successful (step S4 YES), the corresponding file is downloaded from the ASP server (step S5), and the downloaded file is stored into the acquired file memory unit 15 of the home gateway 1 (step S6).

Note that, in this processing procedure, the corresponding file is downloaded immediately when it is detected that the new home electronics device 2 is connected to the home network 4, but instead of that, it is also possible to download the corresponding file when that file is not in possession after a prescribed period has elapsed after the detection. It is also possible to download the corresponding file that is not in possession, by taking an occurrence of a request for the control screen for the new home electronics device 2 from the terminal device 3 or a possibility of being so requested (an occurrence of a request for the available home electronics device list screen containing an icon for the new home electronics device 2 from the terminal device 3, for example) as a trigger, in addition to or instead of taking the detection of the connection of the new home electronics device 2 to the home network 4 as a trigger as described above.

Next, the case of displaying the control screen of the home electronics device on the Web browser 31 of the terminal device 3, and controlling the home electronics device from the terminal device 3 through the home gateway 1 will be described for an exemplary case of the air conditioner.

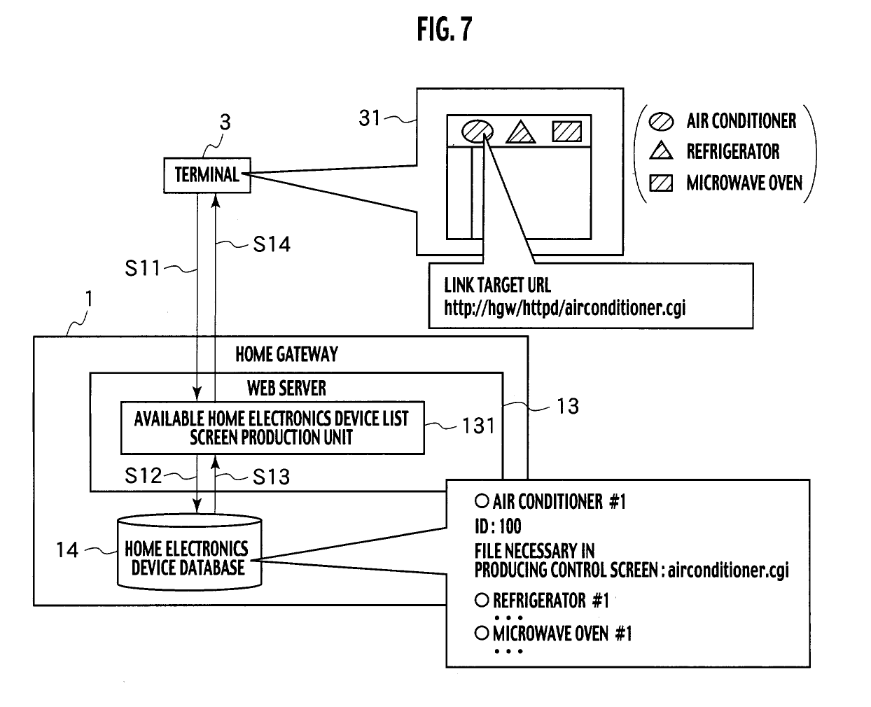

FIG. 7 shows a processing flow in the case where the available home electronics device list screen for the home electronics device control is displayed as an initial screen on the Web browser 31 of the terminal device 3.

At the Web browser 31 of the terminal device 3 where the home electronics device control is desired, the available home electronics device list screen production unit 131 of the home gateway 1 is accessed first (step S11).

Here, it is assumed that the Web browser 31 of the terminal device 3 either knows or can acquire the URL for accessing the available home electronics device list screen production unit 131 of the home gateway 1 (http://hgw/httpd/, for example) or the URL for accessing the Web server 13 of the home gateway 1 (http://hgw/, for example) in the case there is a previous screen.

The available home electronics device list screen production unit 131 that is accessed from the Web browser 31 of the terminal device 3 produces a HTML document for displaying an icon of each home electronics device according to the list of the home electronics devices that is stored in the home electronics device database 14 (steps S12, S13), and provides it to the terminal device 3 (step S14).

For example, when the home electronics device information as shown in FIG. 6 is stored in the home electronics device database 14, the available home electronics device list screen containing an icon for the air conditioner, an icon for the refrigerator and an icon for the microwave oven will be displayed on the Web browser 31.

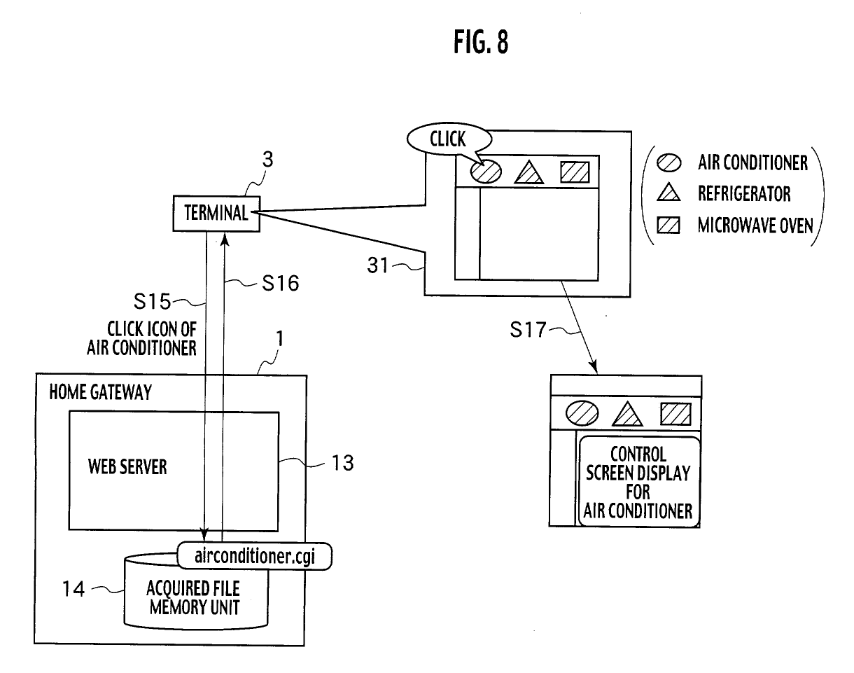

FIG. 8 shows a processing flow in the case where the icon of a specific home electronics device is specified at the available home electronics device list screen displayed on the Web browser 31 of the terminal device 3 and the transition to the control screen of that home electronics device is made.

On the available home electronics device list screen, a file necessary in producing the control screen of each home electronics device 2 is specified to the icon for each home electronics device 2 as a link target in the case of being clicked (see 31 in FIG. 7).

For example, the icon for the air conditioner has a link to “airconditioner.cgi” which is acquired from the ASP server 6 and stored in the acquired file memory unit 15 of the home gateway 1. This link is a link to the local CGI file. That is, the link target URL of the icon for the air conditioner is “http:/hgw/httpd/airconditioner.cgi” that is locally stored by the home gateway 1, rather than the URL “http://asp/httpd/cgifiles/airconditioner.cgi” that indicates the location of the file at the ASP server 6 outside of the home.

When the icon for the air conditioner is clicked (see 31 of FIG. 8) at the available home electronics device list screen on the Web browser 31 of the terminal device 3 (step S15), as there is a link to “http://hgw/httpd/airconditioner.cgi” as described above, the locally stored “airconditioner.cgi” is executed as a result (step S16), and the control screen of the air conditioner (see FIG. 3B) is displayed on the Web browser 31 (step S17).

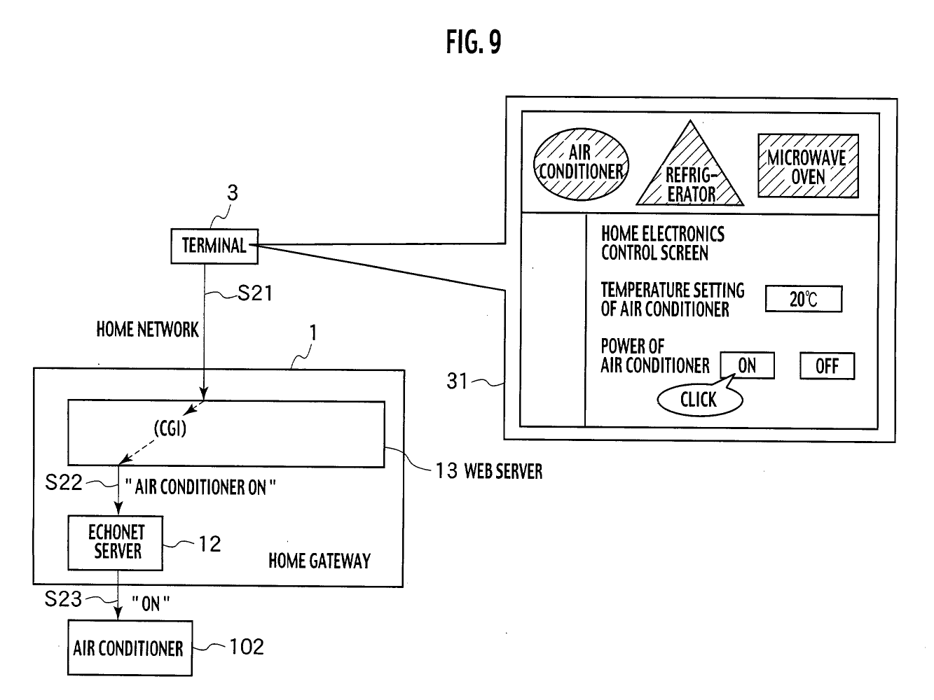

FIG. 9 shows a processing flow in the case where a command for the home electronics device is specified on a screen for the home electronics device control displayed on the Web browser 31 of the terminal device 3.

When the power of the air conditioner “ON” button is clicked on the control screen of the air conditioner (see 31 of FIG. 9), a request message that contains a command for turning the power “ON” for the “air conditioner” as a CGI parameter for example is transmitted from the terminal device 3 to the Web server 13 of the home gateway 1 (step S21).

When this request message is received, the Web server 13 converts the command for turning the power “ON” for the “air conditioner” in terms of the CGI parameter for example into the command for turning the power “ON” for the “air conditioner” according to the ECHONET protocol, and gives it to the ECHONET server 12 (step S22).

Upon receiving the command for turning the power “ON” for the “air conditioner” according to the ECHONET protocol, the ECHONET server 12 transmits a command for turning the power “ON” to the “air conditioner” (step S23).

Note that in the case of carrying out the monitoring or the like of the home electronics device 2 from the terminal device 3 side, it can be done as follows, for example.

First, the home electronics device 2 notifies information regarding its own state either voluntarily and regularly or when a command from the ECHONET server 12 is executed, to the ECHONET server 12 of the home gateway 1, and the ECHONET server 12 maintains the received information for each home electronics device 2.

On the other hand, at the control screen of some home electronics device on the Web browser 31 of the terminal device 3, a command for inquiring a state of the home electronics device is issued to the Web server 13 of the home gateway 1, either voluntarily and regularly or when a prescribed monitoring button is clicked by the user. The Web server 13 inquires the state of the home electronics device to the ECHONET server 12, and transmits a result obtained from a response from the ECHONET server 12 to the terminal device 3, such that it is displayed on the control screen on the Web browser 31.

Now, up to this point, the basic mechanism for acquisition of files necessary in displaying the control screen for the home electronics device 2 has been described. By storing only information indicating the locations of these files at the ASP server 6 outside of the home in the home electronics device 2, and acquiring these files from the ASP server 6, it becomes easier to deal with the home electronics device 2 that is newly connected inside the home. Also, after the files are acquired from the ASP server 6 outside of the home once, the files stored in the acquired file memory unit 15 on the home gateway 1 will be utilized in generating the control screen, so that there is no need to access the ASP server 6 at each occasion of the control screen generation. For example, when the Internet access between the home gateway 1 and the ASP server 6 is no good, it is possible to continue the processing by utilizing the locally stored files without making an access to the ASP server 6.

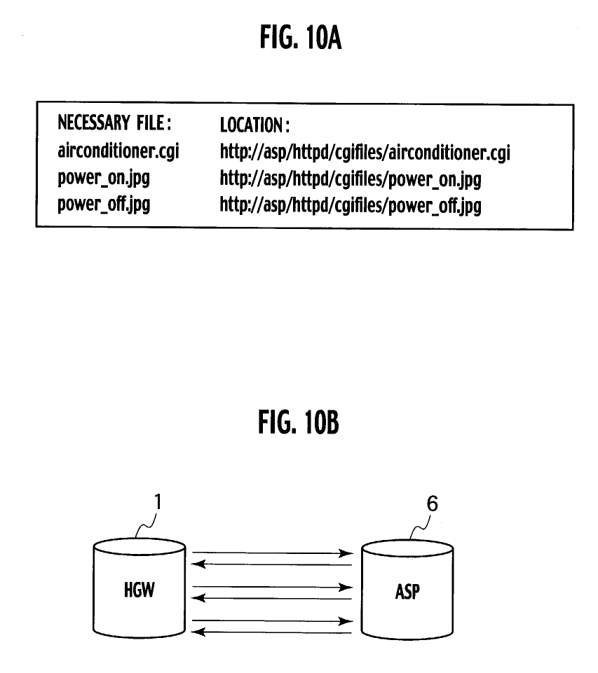

Now, regarding the file acquisition, the above description is directed to the case where there is only one file that is necessary in displaying the control screen of the home electronics device 2 (such as “airconditioner.cgi” for the “air conditioner”, for example), but it is also possible to describe a plurality of files in the home electronics device database 14 as shown in FIG. 10A, where the image files “power_on.jpg” and “power_off.jpg” to be used along with the home electronics device control screen production program “airconditioner.cgi” are described together. In this case, at the steep S2 of FIG. 5, the file acquisition processing unit 11 acquires these files by accessing the ASP server 6 for a plurality of times as shown in FIG. 10B.

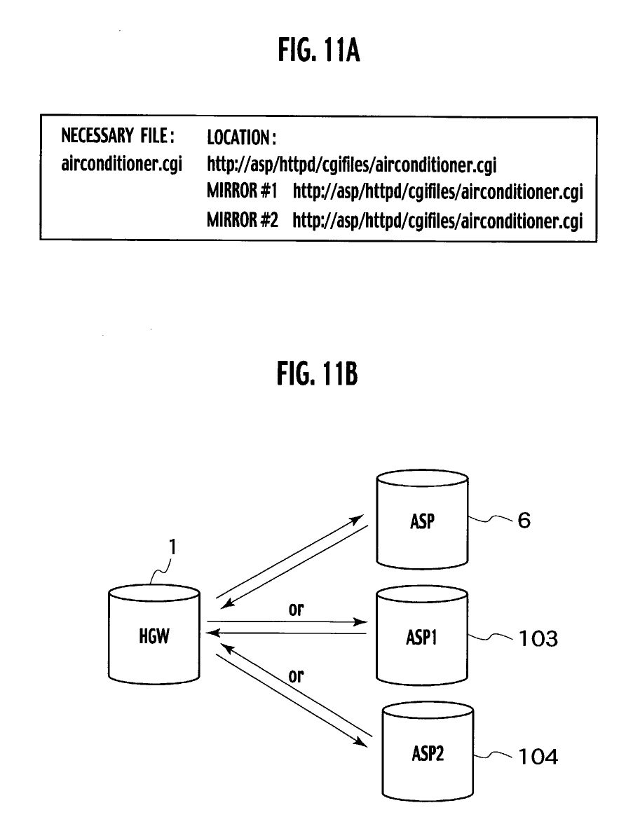

It is also possible to specify a mirror site for the same one file for the purpose of the load balancing as shown in FIG. 11A, such that the file can be acquired from any of these sites as shown in FIG. 11B.

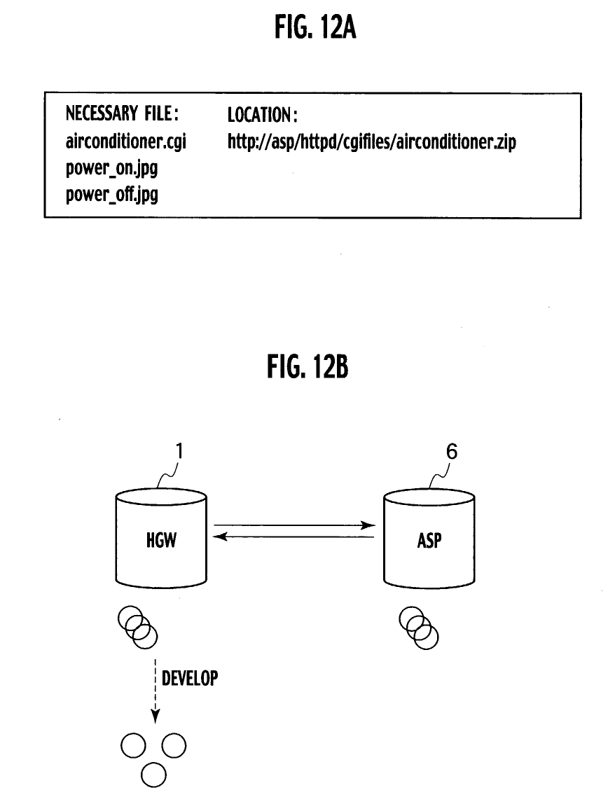

Also, when there are a plurality of files that are necessary in displaying the control screen, it is possible to prepare archives of these files at the ASP server 6 as shown in FIG. 12A, and download the archives and then develop the archives to retrieve the plurality of files later on at the home gateway 1 side as shown in FIG. 12B. In this case, a new mechanism for developing the archives is required in the home electronics device control screen production program, for example, but it is possible to reduce the traffic.

Of course it is also possible to combine the method of FIGS. 11A and 11B with the method of FIGS. 10A and 10B or the method of FIGS. 12A and 12B.

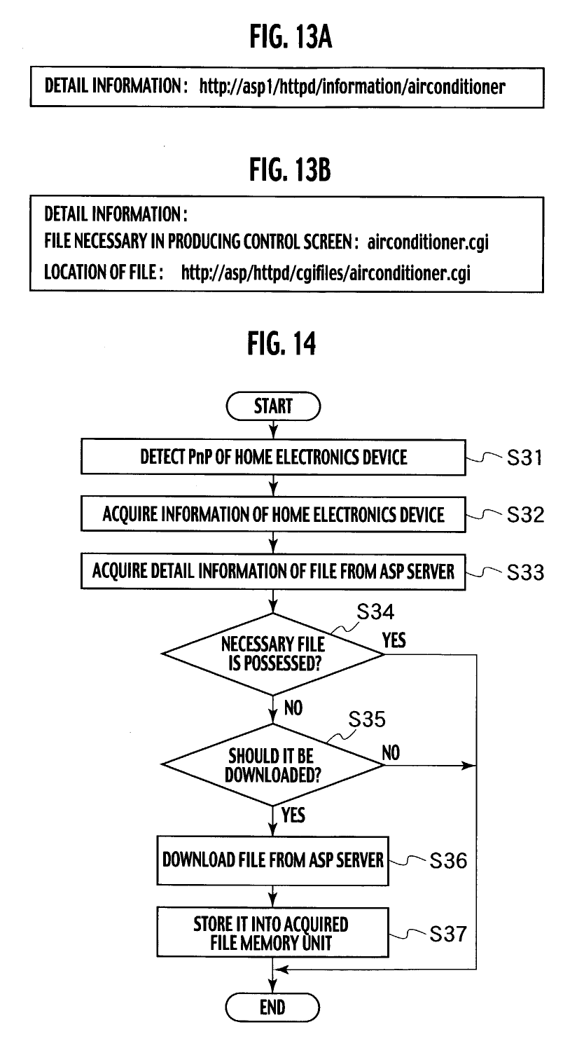

Also, at the step S2 of FIG. 5, the information indicating the location on the ASP server 6 of the file necessary in displaying the control screen of the home electronics device 2 is received by the ECHONET server 12 from the home electronics device 2 itself. However, the home electronics device 2 usually cannot store many information, so that it is also possible to obtain only the information indicating the location to be accessed first (“http://asp1/httpd/information/airconditioner” shown in FIG. 13A, for example) from the home electronics device 2, and acquire the detail information (“airconditioner.cgi” and “http://asp/httpd/cgifiles/airconditioner.cgi” shown in FIG. 13B, for example) by accessing to that location to be accessed first. FIG. 14 shows an exemplary processing procedure in this case. This method makes the procedure somewhat redundant, but there is an advantage in that it suffices to maintain the minimum possible amount of information on the home electronics device 2 side.

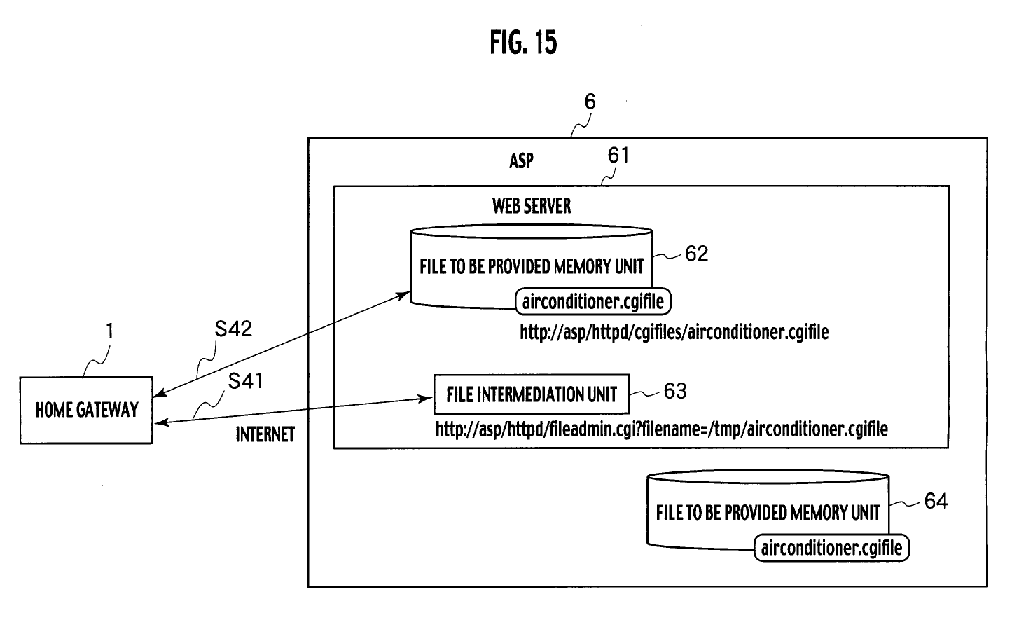

Also, as shown in FIG. 15, regarding the location of the file necessary in controlling each home electronics device that is provided at the ASP server 6, besides placing the file on the location that can be directly accessed by the URL such as “http://asp/httpd/cgifiles/airconditioner.cgi” (the file to be provided memory unit 62), it is also possible to place the file itself at arbitrary location (the file to be provided memory unit 64) and the receive the file through the file intermediation unit 63 on the ASP server 6 by using “http://asp/httpd/cgifiles/fileadmin.cgi?filename=/tmp/airconditioner.cgi”, for example.

The basic processing of the file intermediation unit 63 on the ASP server 6 is to read the specified file and return it as it is as an HTTP response. In addition, by using the file intermediation unit 63 rather than accessing the file directly from the home gateway 1 as in FIG. 4, it is also possible to carry out some additional processing, such as returning a message indicating the illegal access and not returning the file content when there is an access from the illegal home gateway 1, for example.

Note that the file intermediation unit 63 can be realized by executing a file intermediation program.

In the following, the case of automatically updating the file necessary in controlling the home electronics device 2 connected to the home gateway 1 will be described for an exemplary case of acquiring and updating “airconditioner.cgi” necessary in controlling the air conditioner from the ASP server 6.

There can be cases where it is desirable to update the once acquired file to a newer file for the reason such as addition of new functions, for example. The judgement as to whether it should be updated or not can be made by comparing the last updated date and time attached to the file, for example. In attempting the file acquisition, the last updated date and time of the file acquired and stored by the home gateway 1 is compared with the last updated date and time of the file located at the ASP server 6, and the file is actually acquired when the last updated date and time of the file located at the ASP server 6 side is newer. It is also possible to use a method in which the valid period is set to the file so as to reduce the number of inquiries to the ASP server 6. In this case, the inquiry to the ASP server 6 will not be carried out as long as it is within the valid period.

These methods are realized in the general browser in a form of the efficient utilization of a cache, by utilizing tags of HTTP such as “If-Modified-Since (the last updated date and time of the file stored by the home gateway 1), “Last-Modified” (the last updated date and time of the file located at the ASP server 6), and “Expires” (the valid period of the file). By using the similar mechanism at the file acquisition processing unit, it is possible to realize the dynamic updating.

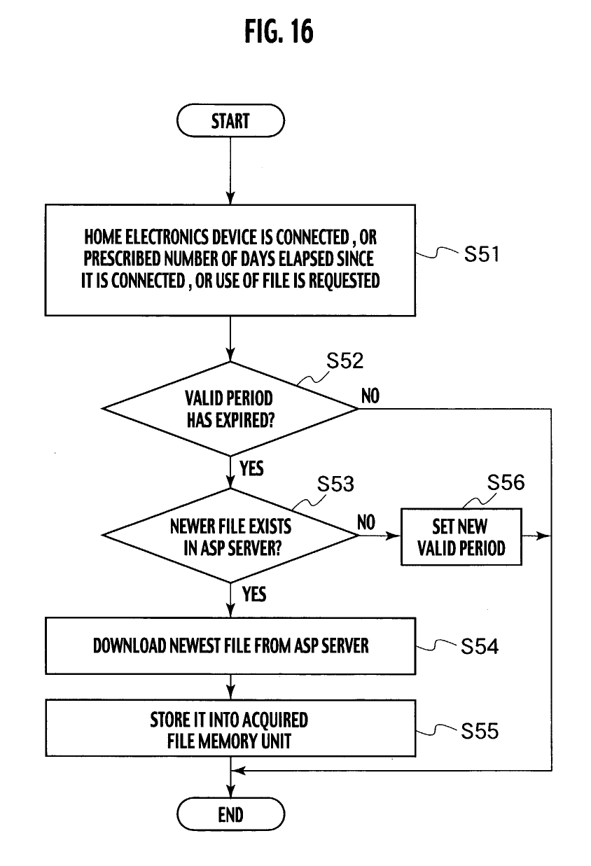

FIG. 16 shows an exemplary processing procedure in the case of dynamically updating the file acquired for each home electronics device 2.

When a prescribed condition holds (step S51), the valid period of the previously acquired file is checked first, and if the valid period has not expired (step S52 NO), no action will be taken.

If the valid period has expired (step S52 YES), whether the newer file is placed at the ASP server 6 or not is checked, and if the newer file exists at the ASP server 6 (step S53 YES), the file is acquired and updated (steps S54, S55).

On the other hand, if the newer file does not exist at the ASP server 6 (step S53 NO), the new valid period is set (step S56).

The value of the valid period may be adjusted to a different value for a different file according to the type of the home electronics device 2, the type of the file, the frequency of updating at the ASP server 6, etc.

Also, the timing for starting this processing (step S51) can be when the home electronics device 2 is connected to the home gateway 1, after a prescribed period has elapsed since it is connected, when the display of the control screen is actually requested from the Web browser 31, when a possibility of being so requested arises (when the available home electronics device list screen is requested, for example), etc.

Note that, in the method for acquiring the file when the home electronics device 2 is connected, the latest functions of the home electronics device 2 become available quicker when the actual request for use of the home electronics device 2 occurs. Also, in the method for acquiring the file at a time of actually using the home electronics device 2, the bandwidth can be utilized efficiently. Consequently, the method to be adopted can be changed depending on the relative importance among the responsiveness and the efficiency.

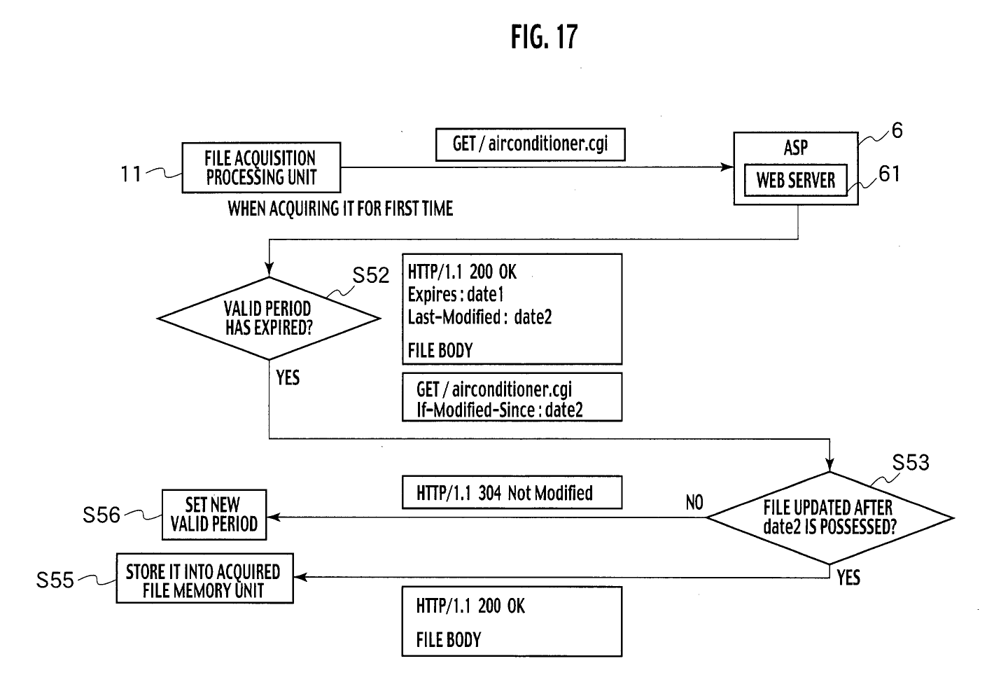

FIG. 17 shows an operation sequence in the case of judging whether the new file should be given to the home gateway 1 or not by comparing the updated date and time using the mechanism of HTTP at the Web server 61 of the ASP server 6.

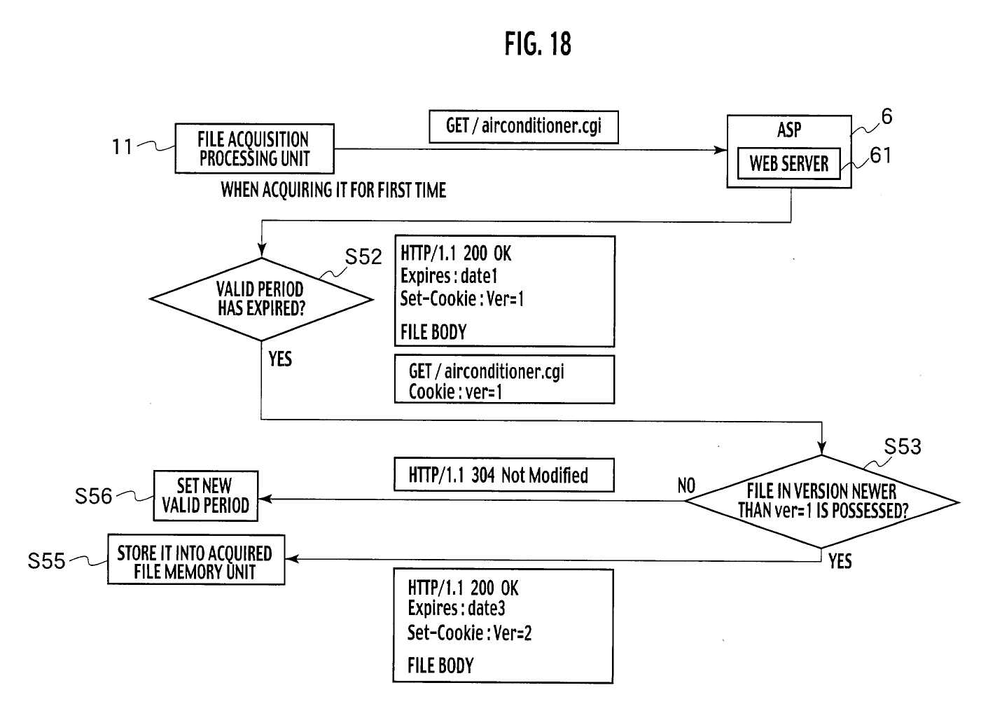

Note that, besides the method using the mechanism of HTTP, it is also possible to introduce a CGI program on the Web server 61 of the ASP server 6 and judge whether the new file should be given to the home gateway 1 or not by using that program. FIG. 18 shows an operation sequence in this case.

In this case, the CGI program of the ASP server 6 receives the version number and the state of the file stored by the home gateway 1, from the home gateway 1 by utilizing cookie, CGI argument, etc. For example, when the ASP server 6 has a file with a newer version number or when the file on the home gateway 1 is broken and a new file is requested, the new file is given to the home gateway 1. By providing such a CGI program, more flexible judgement can be made compared with the case of only comparing the date and time of HTTP.

Note that the updating of the file or the program must be carried out from a proper ASP server 6 as presumed by the home gateway 1, when viewed from the home gateway 1 side. In other words, it is preferable to use a mechanism for preventing the so called “hijacking” in which some malicious ASP server pretends the proper ASP server 6 and updates the file or the program of the home gateway 1 improperly. On the other hand, when viewed from the ASP server 6 side, there can be cases where it is desired to provide the service of updating the file or the program only with respect to the specific home gateway 1. In order to resolve these problems, it is preferable to carry out the authentication of the ASP server 6 from the home gateway 1 and the authentication of the home gateway 1 from the ASP server 6 and encrypt the data exchanged between these devices. This can be realized by using HTTPS instead of HTTP, or by carrying out the authentication and key exchange procedure in advance.

Also, in this embodiment, the controller is arranged outside of the home gateway 1, but it is also possible to arrange the controller (Web browser) inside the home gateway 1. In such a case, the home gateway 1 itself will play the role of the controller. In this case, the overall operation is realized by carrying out internal communications between a portion of the Web server 13 in the home gateway 1 and a portion of the Web browser.

Note that this embodiment is directed to the case where the control screen of the home electronics device is controlled to be displayed on the Web browser 31 of the terminal device 3, but instead of that, it is also possible to transmit a java(R) application for displaying the control screen to the terminal device 3 such that the terminal device 3 displays the control screen of the home electronics device by executing this java(R) application. In this case, the java(R) application for each home electronics device is provided at the ASP server 6 and acquired by the home gateway 1 from there.

As described, according to the present invention, it is possible to automatically acquire and update modules for controlling home electronics devices connected on the home network, through the external network.

For example, when the new home electronics device is purchased and connected to the home network, the communication control device can detect the participation of this home electronics device to the home network, and carry out the downloading of the controlling software module from the external server device. The timing for this downloading of the module is when this home electronics device is detected or when the control screen for this home electronics device is requested by the user at the controller, for example. Note that it is possible to avoid influencing the operation of the other function modules while downloading this function module. Thereafter, whenever the user requests the control screen of this home electronics device at the controller, the communication control device can check whether an updated version of this module exists on the external server device or not, and automatically download the updated version when the update is detected.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the home gateway of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A communication control device connected to a home network and an external network, comprising:
a control unit configured to give prescribed commands to home electronics devices through the home network;
a Web server unit configured to provide an interface in a form of a Web screen for controlling one home electronics device requested by a terminal device, to the terminal device on the home network, and give a prescribed command for the one home electronics device given from the terminal device through the interface in a form of the Web screen, to the control unit; and
an acquisition unit configured to automatically acquire a latest version of a file necessary in producing the interface in a form of the Web screen for controlling each home electronics device, from a prescribed server device corresponding to each home electronics device, through the external network.

2. The communication control device of claim 1, wherein the Web screen for controlling the one home electronics device provided to the terminal device contains icons for inputting commands for the one home electronics device, and
when a request containing the prescribed command for the one home electronics device is received from the terminal device as an icon for inputting the prescribed command is operated at the Web screen on the terminal device, the Web server unit requests the control unit to give the prescribed command to the one home electronics device, in response to the request.

3. The communication control device of claim 1, wherein the control unit and the home electronics devices are operated according to a prescribed home electronics device control protocol, and
the Web server unit converts the prescribed command for the one home electronics device given from the terminal device through the interface in a form of the Web screen into a command for the one home electronics device according to the prescribed home electronics device control protocol, and gives a converted command to the control unit.

4. The communication control device of claim 3, wherein the prescribed home electronics device control protocol is an ECHONET protocol, and the control unit is an ECHONET server.

5. The communication control device of claim 1, wherein the Web server unit provides another Web screen that contains icons corresponding to the home electronics devices as another interface for selecting each home electronics device existing on the home network, in response to a request from the terminal device, and
when another request for the Web screen for controlling the one home electronics device is received from the terminal device as an icon corresponding to the one home electronics device is selected on the another Web screen on the terminal device, the Web server unit provides the interface in a form of the Web screen for controlling the one home electronics device to the terminal device, in response to the another request.

6. The communication control device of claim 5, further comprising a memory unit configured to store the file acquired by the acquisition unit,
wherein the another Web screen for selecting each home electronics device contains an icon corresponding to each home electronics device to which the file corresponding to each home electronics device stored in the memory unit is set in correspondence as a link target in a case the icon corresponding to each home electronics device is selected.

7. The communication control device of claim 1, wherein the control unit has a function for detecting each home electronics device connected to the home network, and
the acquisition unit acquires the file from the prescribed server device only for each home electronics device detected by the control unit.

8. The communication control device of claim 7, wherein the control unit has a function for collecting home electronics device information regarding each home electronics device connected to the home network, and
the acquisition unit acquires the file from the prescribed server device according to information indicating the prescribed server device corresponding to each home electronics device and information indicating the file corresponding to each home electronics device which are containing in the home electronics device information collected by the control unit.

9. The communication control device of claim 8, wherein the home electronics device information contains a specific address at the prescribed server device corresponding to each home electronics device as a location of the file corresponding to each home electronics device.

10. The communication control device of claim 7, wherein the acquisition unit acquires the file from the prescribed server device when or a prescribed period of time has elapsed after the control unit detects that a new home electronics device is connected to the home network.

11. The communication control device of claim 7, wherein the acquisition unit acquires the file from the prescribed server device when the file becomes necessary or when a possibility for the file to become necessary arises for any home electronics device for which a corresponding file is not yet acquired from the prescribed server device.

12. The communication control device of claim 7, wherein the acquisition unit checks whether the file acquired from the prescribed server device for each home electronics device has been updated at the prescribed server device or not when a prescribed condition holds, and acquires an updated file from the prescribed server device when the file has been updated.

13. The communication control device of claim 12, wherein the prescribed condition holds when or a prescribed period of time has elapsed after the control unit detects that each home electronics device is connected to the home network, or when a need or a possibility of the need to provide the Web screen for controlling each home electronics device to the terminal device arises.

14. The communication control device of claim 1, wherein when the file contains a plurality of programs, the acquisition unit requests the prescribed server device to transfer a plurality of programs contained in the file collectively.

15. The communication control device of claim 1, wherein the acquisition unit has a security function for carrying out at least one of a device authentication and a communication data transfer using encryption, at a time of carrying out communications with the prescribed server device.

16. The communication control device of claim 1, wherein the Web server unit operates with the terminal device which is any one of PC, TV, portable telephone terminal, and PDA.

17. A communication control method of a communication control device connected to a home network and an external network, comprising:
acquiring a location information indicating a location on the external network of a file necessary in producing an interface in a form of a Web screen for controlling a new home electronics device, from the new home electronics device detected on the home network;
automatically acquiring a latest version of the file according to the location information when a prescribed condition holds; and
providing the interface in a form of the Web screen for controlling one home electronics device requested from a terminal device on the home network, according to the file, in response to a request from the terminal device.

18. The communication control method of claim 17, further comprising:
checking whether an acquired file has been updated at the location the external network or not when another prescribed condition holds, and acquiring an updated file according to the location information when the file has been updated.

19. The communication control method of claim 17, further comprising:
giving a prescribed command for the one home electronics device to a control unit for controlling home electronics devices, when the prescribed command for the one home electronics device is received through the interface in a form of the Web screen from the terminal device to which the interface in a form of the Web screen for controlling the one home electronics device is provided.

20. A computer program product for causing a computer to function as a communication control device connected to a home network and an external network, the computer program product comprising:
a first computer program code for causing the computer to give prescribed commands to home electronics devices through the home network;
a second computer program code for causing the computer to provide an interface in a form of a Web screen for controlling one home electronics device requested by a terminal device, to the terminal device on the home network, and give a prescribed command for the one home electronics device given from the terminal device through the interface in a form of the Web screen, to the first computer program code; and
a third computer program code for causing the computer to automatically acquire a latest version of a file necessary in producing the interface in a form of the Web screen for controlling each home electronics device, from a prescribed server device corresponding to each home electronics device, through the external network.
